(19) United States
(12) Patent Application Publication
(10) Pub. No.: US 2012/0296743 A1
(43) Pub. Date: Nov. 22, 2012

(54) Method and System for Personalized Search Suggestions

(75) Inventors: Omer Emre Velipasaoglu, San Francisco, CA (US); Umut Ozertem, Sunnyvale, CA (US)

(73) Assignee: YAHOO! INC., Sunnyvale, CA (US)

(21) Appl. No.: 13/111,058

(22) Filed: May 19, 2011

(51) Int. Cl. G06Q 30/00; G06F 17/30; G06Q 20/00; G06F 7/00

(52) U.S. Cl. 705/14.54; 707/767; 707/706; 705/39; 707/E17.108

(57) ABSTRACT

Method, system, and programs for providing personalized suggest-as-you-type suggestions in response to a user search query wherein the personalized query suggestions are based on the user's past interactions with the system. The system is able to identify frequent queries issued by the user that result in the user clicking on the same universal resource locator.

### BACKGROUND

1. Technical Field

The present teaching relates to methods, systems and programming for generating personalized search suggestions and content. Particularly, the present teaching is directed to methods, systems, and programming for providing personalized suggestions as the user types search queries.

2. Discussion of Technical Background

The advancement in the world of the Internet has made it possible to make a tremendous amount of information accessible to users located anywhere in the world. To locate information on the Internet users typically utilize some form of search engine that allows a user to input a search query in the hopes of locating relevant information. Along that line, different techniques have been developed to automatically aid users in such endeavors. For example, techniques exist to suggest search queries to users as they are entering or typing information into a search engine. This is known as “suggest-as-you-type” information. The most often employed form of suggest-as-you-type is based on the most commonly used search or most frequently used terms for the population as a whole. That is, the most popular search queries will always be suggested to the user regardless of the user's personal search history or searching habits.

Not all users are the same however, and an analysis of a user's search queries reveals that a user will typically reissue identical or similar queries in the same search session or over an extended period of time. This “bookmark” like behavior in the issuance of search queries usually is a results of a user using reissued queries as a navigational tool to lead the user to a particular web site or URL.

The repeated issuance of identical or similar queries may also be seen when a user is in a research mode. For example, where the user has a short-term intent like buying a product or planning a vacation, and has a transient interest in a particular query. Take for example, a user who skis in Lake Tahoe every weekend during the ski season. The user may enter the search query “Lake Tahoe ski conditions” every few hours prior to each weeks trip during the season. A problem occurs however, if the user who is repeatedly searching for the ski conditions is presented with the same irrelevant suggest-as-you-type suggestions every time they start to enter the search prefix “Lak . . . ”. The user will ignore the suggestions, and the purpose of assisting the user in formulating a search query is undermined. In the above example, if when the user begins to type “Lak . . . ” and the corresponding suggest-as-you-type suggestion corresponding to the early portion of the query or prefix relate to Lake Michigan and not Lake Tahoe, the user will simply ignore the suggestions and will not benefit from the search as you type feature.

Hence, existing search as you type solutions, although useful in certain situations/applications, do not address the bookmarking behavior of many users. Therefore, there is a need to develop a system that recognize a user's specific search habits and uses each individual user's search history to provide relevant personalized search assistance for the suggest-as-you-type feature as early as possible during the query entry.

### SUMMARY

The teachings disclosed herein relate to methods, systems, and programming for providing personalized search queries. More particularly, the present teaching relates to methods, systems, and programming for providing personalized suggestions as the user types search queries.

In one example, a method, implemented on a machine having at least one processor, storage, and a communication platform connected to a network for providing personalized search query suggestions is disclosed. The method comprising receiving, via the communication platform, a portion of a query originated from a user. Comparing the received portion of the query to data stored in a database. Generating at least one set of query suggestions based on the comparing, and transmitting via the communications platform, the at least one set of query suggestions, wherein at least at least one set of query suggestions is based on information stored in a personalized database.

In another example, a method further comprises associating and displaying personalized content that corresponds to at least one set of query suggestions and transmitting the content via the communications platform.

In another example, the method is implemented on a machine having at least one processor, storage, and a communication platform connected to a network for generating a personalized query suggestion. The method comprises receiving a first search query originated from a user. Monitoring a response to the search query and comparing the response and the search query to data in a database. Updating the database based on the results of the comparing and storing the query and the response in a personalized database. Finally, outputting a personalized suggestion to a future query related to the first query based on the response stored in the personalized database.

In another example, the storing of the query occurs in response to the updating exceeding a frequency threshold.

In another example, the storing includes storing a plurality of different queries associated with a single universal resource locator.

In a further example, the method comprises outputting personalized content related to the personalized suggestion.

In another example of the method, the personalized suggestions are ranked based on the user's interactions with past suggestions. In another further example, the method comprises removing the query and the response entered by a first method from the personalized database when it exceeds a temporal threshold.

In one example, a machine readable non-transitory and tangible medium having information recorded thereon for suggesting personalized queries, wherein the information, when read by the machine, causes the machine to receive a first search query originated from a user is disclosed. In the example, the system monitors a response to the search query and compares the response and the search query to data in a database. The medium further causes the machine to update the database based on the results of the comparing and store the query and the response in a personalized database and output a personalized suggestion to a future query related to the first query based on the response stored in the personalized database.

In another example, the medium further comprises outputting personalized content related to the personalized suggestion.

In another embodiment, a method for presenting personalized content such as advertisements, URLS, or other web resources the user has interacted with is disclosed wherein the personalized search queries associated with a user are tracked. Information related to a plurality of advertisements from an advertiser are received, URLS, or other web resources the user has interacted with can be displayed along with the personalized suggestions. One or more personalized content are associated with respect to the one or more personalized search queries, and the one or more advertisements, URLs or other personalized content are presented when the one or more personalized search queries are displayed.

In another embodiment, information related to presentation of the one or more advertisements in connection with the one or more personalized search queries is obtained. Statistics associated with the presentation of the one or more advertisements are determined and records associated with the advertiser in connection with the one or more advertisements based on the statistics are updated and payment is made in association with the one or more advertisements based on the record.

In another embodiment, a system for providing personalized query suggestions comprising a personalized query engine configured for receiving, processing, and generating personalized search queries based on a search query prefix entered by a user, and a search engine configured for receiving the search query prefix from a user is disclosed. Wherein, upon receiving a search query prefix from the user, the personalized query engine retrieves information from a knowledge storage associated with the user, generates one or more one or more personalized search queries, and transmits the one or more personalized search queries in response to the search query prefix.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 (a)-(b) depicts examples of suggest as you type as disclosed in the prior art;

FIG. 2 is a high level depiction of an exemplary system in which personalized suggest-as-you-type is applied, according to a first application embodiment of the present teaching;

FIG. 3 is a high level depiction of an exemplary system in which personalized suggest-as-you-type is applied, according to a second application embodiment of the present teaching;

FIG. 4 depicts a schematic representation of a suggest-as-you-type display, according to an embodiment of the present teaching;

FIG. 5 depicts a data structure for storing information in a personalized user database, according to an embodiment of the present teaching;

FIG. 6 is a flowchart of an exemplary process of the personalized suggest-as-you-type system according to an embodiment of the present teaching;

FIG. 7 schematic representation of a skipped click in the personalized suggest-as-you-type system according to an embodiment of the present teaching

FIG. 8 is a flowchart of an exemplary process in which the detection stage of a personalized query engine operates to provide personalized suggest-as-you-type information in response to user queries, according to an embodiment of the present teaching;

FIG. 9 is a flowchart of an exemplary process in which the exact query click stage of a personalized query engine operates to provide personalized suggest-as-you-type information in response to user queries, according to an embodiment of the present teaching;

FIG. 10 is a flowchart of an exemplary process in which the exact query click eliminate stage of a personalized query engine operates to provide personalized suggest-as-you-type information in response to user queries, according to an embodiment of the present teaching;

FIG. 11 is a flowchart of an exemplary process in which the non-exact query identical click stage of a personalized query engine operates to provide personalized suggest-as-you-type information in response to user queries, according to an embodiment of the present teaching;

FIGS. 12(a)-(c) depict examples of single web clicks in a personalized query engine that operates to provide personalized suggest-as-you-type information in response to user queries, according to an embodiment of the present teaching;

FIG. 13(a) depicts examples of single web clicks following a query used in a personalized query engine that operates to provide personalized suggest-as-you-type information in response to user queries, according to an embodiment of the present teaching;

FIG. 13(b) depicts a URL dictionary of single web clicks following a query used in a personalized query engine that operates to provide personalized suggest-as-you-type information in response to user queries, according to an embodiment of the present teaching;

FIG. 14 is a flowchart of an exemplary process in which the ranking of personalized suggestions in a personalized query engine operates to provide personalized suggest-as-you-type information in response to user queries, according to an embodiment of the present teaching;

FIG. 15 is a schematic representation of a search engine display in a suggest-as-you-type system that displays personalized content related to the personalized suggest-as-you-type suggestions, according to an embodiment of the present teaching;

FIG. 16 is a schematic representation of a search engine display in a suggest-as-you-type system that displays personalized content related to the suggest-as-you-type suggestions, according to an embodiment of the present teaching;

FIG. 17 is a schematic representation of a search engine display in a suggest-as-you-type system that displays content related to the suggest-as-you-type suggestions, according to an embodiment of the present teaching; and

FIG. 18 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to providing search engine users with personalized query suggestions as they type their desired query. It has been found that users often reissue queries in a bookmark like behavior, where the reissued queries are of a navigational nature rather than a search nature. The search is typically followed by a single identical click despite variations in the queries.

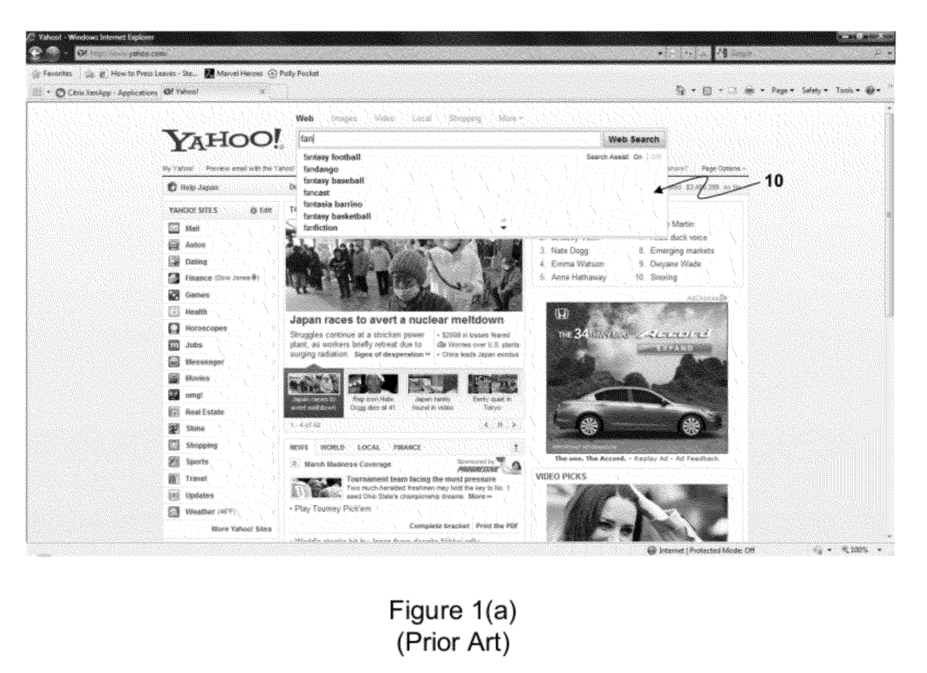

FIG. 1(a), depicts the suggest-as-you-type method existing in the art. A user interested in information about or in the Internet site related to “Fanfare”, will always be presented with query suggestion list 10 regardless of how many times the user begins to type or enters the prefix for their search for “Fanfare”. As can be seen query suggestion list 10 does not suggest Fanfare even after the user has entered three characters of the search string. It is not until the user enters “Fanf” in FIG. 1(b) that the query suggestion list 10 suggests “fanfare” as a search query and then as the second entry on the list. This type of response will be repeated every time the user enters the “Fanfare” query no matter how many times the user enters the search. The existing search-as-you-type algorithm is based on frequency of search queries across all search engine users and is not specific to a particular user. In this instance, the user who frequently is seeking information about “Fanfare” and who may be using the query function as a pseudo bookmark, i.e., visits the site often but always by issuing a search command, will benefit little from the search-as-you-type feature of many present day search engines if the desired query is not suggested at the start of the user entering the query prefix.

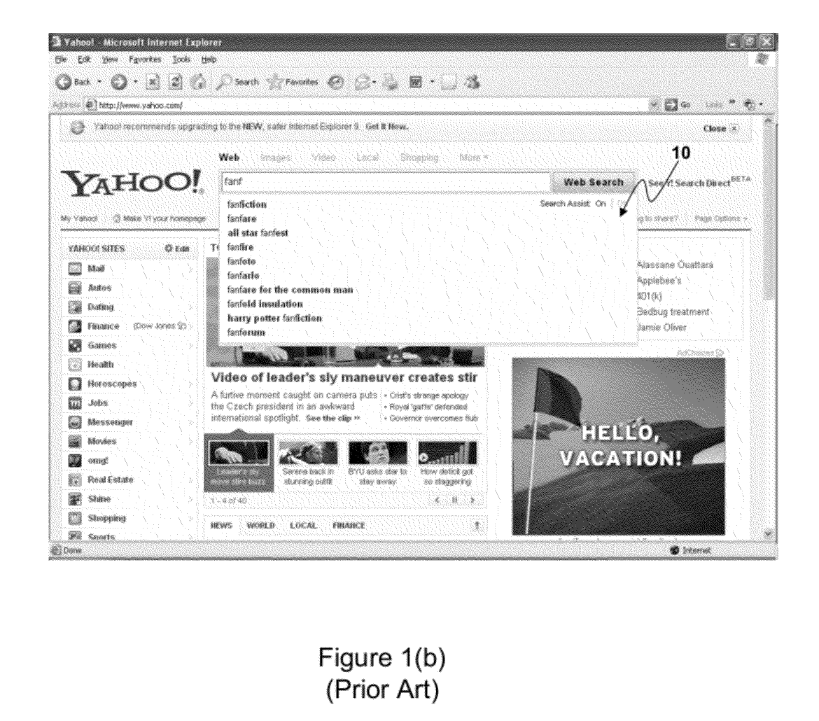

FIG. 2 is a high level depiction of an exemplary system 200 in which a personalized query engine 240 is deployed to provide personalized search queries, according to a first embodiment of the present teaching. The exemplary system 200 includes users 210, a network 220, a search engine 230, personalized query engine 240, a user long term database 250, a short term search history database 260, a personalized database 270, a query database 280, communication path 290 and content system 310. The network 220 in system 200 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points, through which a data source may connect to the network in order to transmit information via the network.

In this embodiment, the personalized query engine 240 serves as a backend system of the search engine 230. All user 210 queries are sent to the search engine 230, which then invokes the personalized query engine 240 to process the search-as-you-type query.

Users 210 may be of different types such as users connected to the network via desktop connections (210-d), users connecting to the network via wireless connections such as through a laptop (210-c), a handheld device (210-a), or a built-in device in a motor vehicle (210-b). A user may begin a search query via search engine 230 which is conveyed via network 220 and likewise receive the search-as-you-type query results from the search engine 230 through the network 220. In the embodiment depicted in FIG. 2, a user's query originates with a user 210, it is communicated to network 220 via a wired or wireless connection 290 and is routed through search engine 230 to a back end personalized query engine 240. Personalized query engine 240 will determine if the user 210 has a personalized database 270, and if the current query is stored in the personalized database 270. Personalized query engine 240 will return any personalized queries from personalized database 270 and will also collect common queries from query database 280 via search engine 230 over network 220 to user 210. In this manner, the user 210 will receive personalized search-as-you-type information as well as traditional frequency based suggestions to fill out query suggestion list 10. In an embodiment, a maximum of three personalized queries were returned from personalized database 270 and 5 user queries from query database 280, although any combination may be employed. This provides the user with his highest ranked personalized suggestions and most frequent suggestions, affording the user 210 the best chance of receiving the correct search-as-you-type query. Additionally, content system 310 may also convey via search engine 230 any additional content or links to content, such as advertising content, URLs, third party content or any other information associated with the user 210 personalized search-as-you-type information that may be conveyed to a user.

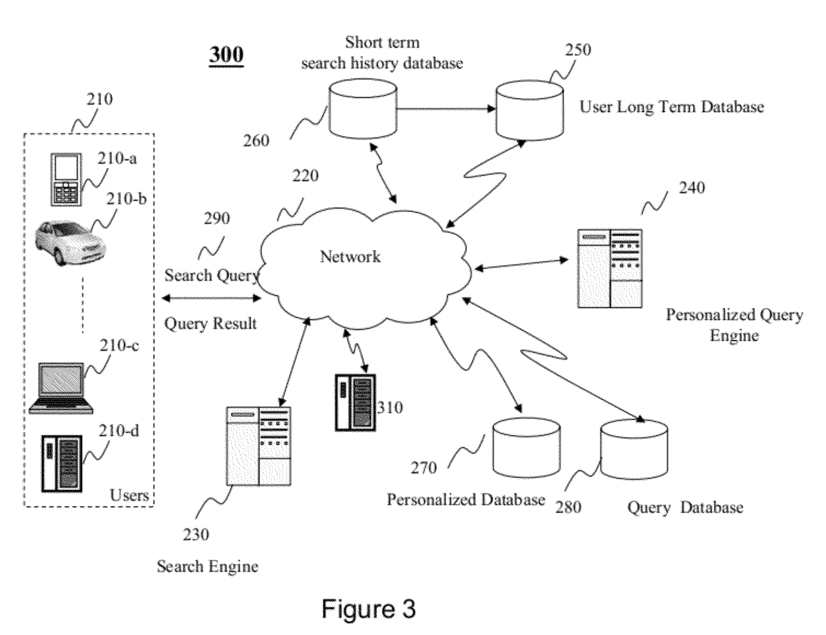

FIG. 4 depicts the layout of query suggestion list 10 in an embodiment of the invention. As a user enters a query in query box 41, personalized search-as-you-type responses 42 will be given the highest priority on query suggestion list 10 based on a rank by personalized query engine 240. Traditional frequency based suggestions 44 will also be included in query suggestion list 10 so that a user who is searching for the common search-as-you-type suggestion will have access to the most common suggestions as well.

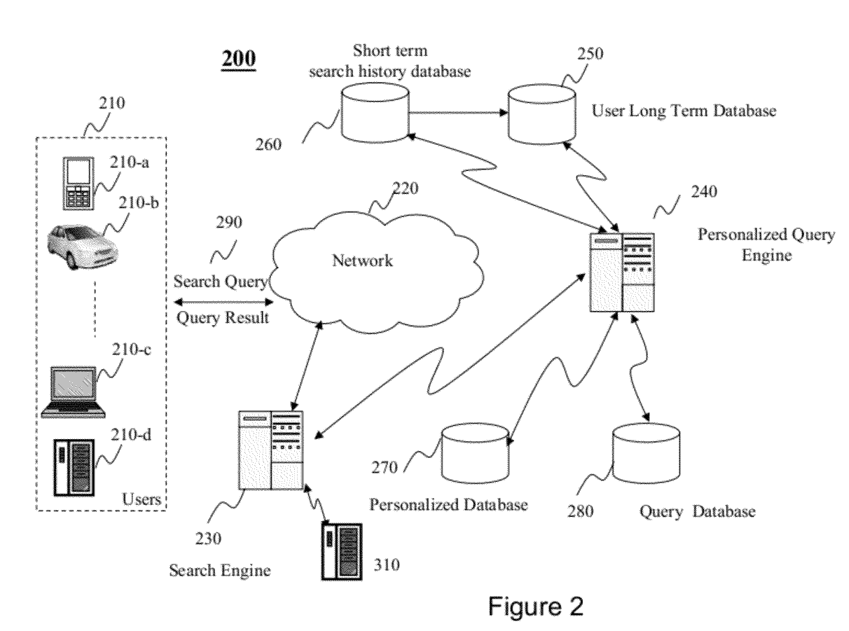

FIG. 3 is a high level depiction of an exemplary system 300, where search engine 230, personalized query engine 240, user long term database, 250, short term search history database 260, personalized database 270, query database 280, users 210 and content system 310 are all connected directly to network 220. In this embodiment, a user's search-as-you-type queries may be routed directly to personalized query engine 240 or to search engine 230 via network 220. Likewise, the various databases 250-280 may be distributed on network 220 and provide different parts of the search-as-you-type data to search engine 230 or personalized query engine 240 depending on the distributed architecture. The personalized query engine 240 may access information, via the network 220, stored in the personalized database 270 and query database 280, which may contain, e.g., personalized query information contained in personalized database 270, etc. The information in the user long term database 250 may be generated by one or more long term databases and short term search history database 260 also connected to the network. As depicted, personalized query engine 240 may operate at the backend of the search engine 230, or as a completely stand-alone system capable of connecting to the network 220, accessing information from different sources, analyzing the information, generating search-as-you-type queries and storing such generated information in the personalized database 270.

In this embodiment, as in the prior, the user will receive a search-as-you-type query suggestion list 10, as depicted in FIG. 4.

In an embodiment, search engine 230 may be any Internet search engine, such as Yahoo, Bing, Google, or any other search engine that is intended to aid users 210 with searching for content on the Internet. A content source may correspond to a web page host corresponding to an entity, whether an individual, a business, or an organization such as USPTO.gov, a content provider such as cnn.com and Yahoo.com, or a content feed source such as tweeter or blogs.

In the exemplary system 200, a user may begin entering, in a browser, a query as a bookmark type query or to obtain information related to the entity about an entity (e.g., “Fanfare”) which may be conveyed to search engine 230. In some embodiments, this query may be first sent to the search engine 230 and then re-directed to the personalized query engine 240, if the search engine 230 operator contracts with the operator of the relationship explanation engine 240. In such a configuration, the search-as-you-type output from the personalized query engine 240 may be sent back to the search engine 230 so that they can be re-directed to the user as a response to the inquiry. Alternatively, the personalized query engine 240 may return the search-as-you-type queries back to the user directly, if the user's information is, e.g., forwarded to the personalized query engine 240 when the query is entered. In some configurations, a browser running on a user's device is configured to appropriately direct different inquiries to different systems via the network 220.

In one embodiment, user long term database 250 is a database of a user 210's queries and the URL clicks that follow them. Utilizing b-cookies, user query and URL data is gathered and stored in user long term database 250 typically for a sliding three month period, although longer or shorter periods may be utilized. By analyzing user 210's queries and the responses that follow over time, one can make a determination about the user's search habits, i.e., is the user using the search as a bookmark, that is, is the user issuing the same query frequently followed by identical or nearly identical URL clicks. As noted above, the data stored in the user long term database 250 must be gathered over a period of time and will not be helpful when a user may be interested in a query and respective URL for a short period of time, i.e., in relation to a specific purchase, vacation or other one time or seasonal event.

In an embodiment, short term search history database 260 may be used to collect and gather user query and click data on a near real-time basis, thereby providing the user with personalized search-as-you-type data even for short term queries. Entries in the short term search history database 260 contains the user id, a timestamp, the query entered, and the resultant URL clicked by the user. Such short term data allows for personalized search-as-you-type results to be mined and utilized in near real time. While such data will also be stored in user long term database 250, its transient nature may never allow it to rise to the level of bookmark type data, as the user may abandon the query and click after the event, i.e., purchase, vacation, etc., is completed. As a result, short term search history database 260 gathers data based on userID or cookies, as the user is interacting with search engine 230. In an embodiment, short term search history database 260 data is written on a periodic basis, typically, every 24 hours to user long term database 250, although other intervals are possible

Query database 280 comprises queries and URL (or search result) clicks, not specific to user 210, but to the searching population as a whole. It contains the most frequently clicked URLs for a particular query and is utilized in existing search-as-you-type systems to provide the most frequent search-as-you-type suggestions to a particular query prefix.

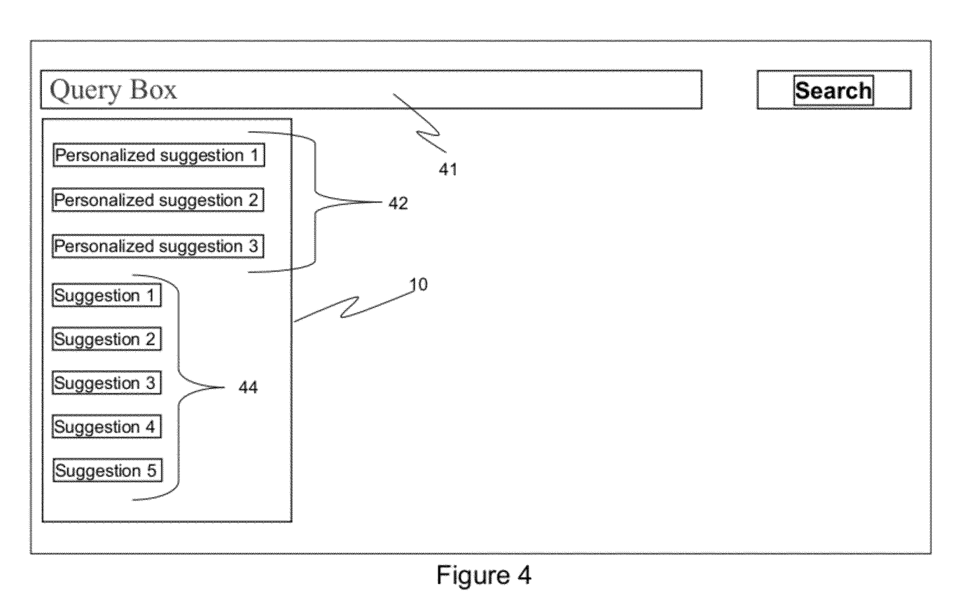

Personalized database 270 in an embodiment of the present invention, is a specific user database populated with user query and click data gathered from the user 210's long term database 250 data and short term search history database 260 data. By analyzing the data from both the long term database 250 and short term search history database 260 in parallel, the personalized database 270 can be built to reflect the user's search-as-you-type database. The key to the personalized database 270 is the query data along with the personal information i.e., browser cookie (bcookie) or userID. Personalized database 270 may also contain information about a user's content preferences along with the user's query preferences. For example, personalized database 270 may contain the query as well the URL and offer both as suggestion in tandem or separately when needed. An embodiment of the data structure utilized in personalized database 270 is depicted in FIG. 5.

Query 502 is the query entered by the user, in the web browser. UserID 504 may be a bcookie or a UserId, or any another value associated with user 210 or a user's computer, smart phone, tablet, or other device that may be used by a user to search a network. Query 502 along with UserID 504 form the key for the data entry. Timestamp 506 represents the time and date the query was entered into the database, URL 508 represents the Uniform Resource Locator (URL) that the user clicked immediately after the query or in response to the query results. Flag 510 represents whether the entry is a result of an Exact Query Click (EQC) from the short term search history database 260 or a Non-Exact Query Single Identical Click (NEQSIC) from the user long term database 250. In one embodiment, a 1 represents an EQC entry and a 2 represents a NEQSIC entry, although any single or multiple digit entry may be used. K_Value 512 represents the number of times the EQC or NEQSIC event happened. Initially the K_Value 512 will be pre-selected and uniform for every query written into personalized database 270. Once the query 502 is in personalized database 270, K_Value 512 may increase with feedback from the user's interaction with the suggested queries. Nclick 514 represents the number of times the personalized query 502 is clicked from the Personalized search-as-you-type response menu 10 when it is suggested. Initially, Nclick 514 is set to zero and increases with feedback from the user's interactions with the suggestions. Nskip 516 is the number of times the personalized search-as-you-type response 42 is skipped and a lower ranked suggestion is clicked. The lower ranked suggestion may be a personalized suggestion 42 or a general suggestion 44. This value is also initially set to zero and increases with user/front end feedback. Alpha_q 518 is a non zero known constant estimate value for Nclick 514 that may be utilized to prevent mathematical errors, such as a divide by zero error. Beta_q 520 is a non zero known constant estimate value for Nskip 516 that may be utilized to prevent mathematical errors, such as a divide by zero error. Score 522 is a score derived from ((Nclick+alpha_q)/(Nclick+Nskip+alpha_q+beta_q)). In an embodiment, score 522 may be utilized to rank the personalized query/URL relationship in personalized database 270. All entries in personalized database 270 are query+user level features except alpha_q 518 and beta_q 520 which are only query level features.

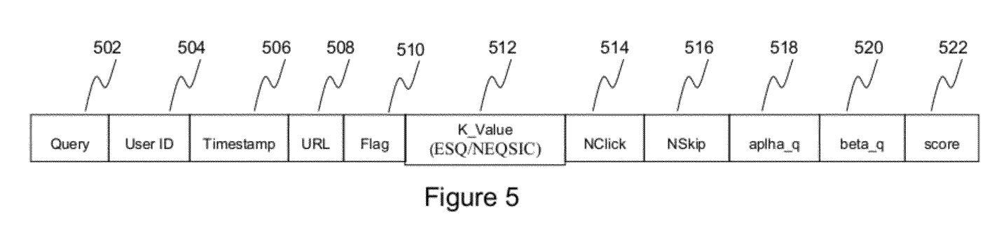

FIG. 6 represents a user's interactions with an embodiment of the exemplary system 200 or 300. At step 605, a user starts to enter a query in a search engine browser. The user's query is compared to entries in the user's personalized user query database 270 to determine if there is an entry for the personalized query in personalized database 270 that corresponds to the current query. If there is no current matching personalized query suggestion, then the user's query is written to the short term search history database 260 at step 645. If there is a matching personalized suggestion, at step 615 the highest ranked personalized suggestions from database 270 are selected. In an embodiment, the top three suggestions are used, although more or less personalized suggestions may be used without departing from the embodiment. At step 620, the three highest ranked general suggestions are selected from query database 280. At step 625, the two sets of suggestions are combined into a single set of suggestion. At step 630 the personalized suggestions from database 270 are compared to the user suggestions from database 280 to check for duplications. If there are no duplication, then at step 635 the combined set of suggestions is transmitted back to the front end to be display for the user with the highest ranked personalized suggestion first, followed by the next highest ranked personalized suggestion, etc. the personalized suggestions are followed by the user suggestions. If there are duplications, they are removed at step 640 and then sent to step 635 and reordered as above. At step 650 the front end monitors the user's activities and reports which if any of the personalized suggestions the user click or skips and updates the user personalized database 270 accordingly. In an embodiment, personalized content from content system 310 may also be suggested at step 655 to the user 210 during step 635. The content may be paid advertisement, URLs or other web based content related to user 210's query, it may be related to alternatives to the user's query suggestions or any other content available. The content may be related to the search history based query suggestions. It may be, for example the URL for which NClick is recorded for the history query under consideration in the date update process.

In an embodiment, the information gathered at step 650 is utilized to populate and update the user's personalized search query database 270. Each time a user interacts with the personalized query suggestion, the data is utilized to provide for a better experience in the future. That is, after each interaction the user has with the personalized query suggestion, the data needs to be updated at step 650 in the personalized user database 270 to reflect the suggestion that was followed, i.e., clicked, and the suggestion that may have been skipped.

With each interaction, there may be a clicked suggestion, a skipped suggestion or no suggestion followed. For a clicked suggestion, timestamp 506 is updated, K_Value 512 is incremented, Nclick 514 is incremented by 1 and score 522 is recomputed with the new Nclick 514 value. For skipped suggestions, Nskip 516 is incremented by 1 and score 522 is recalculated using the new Nskip 516 value.

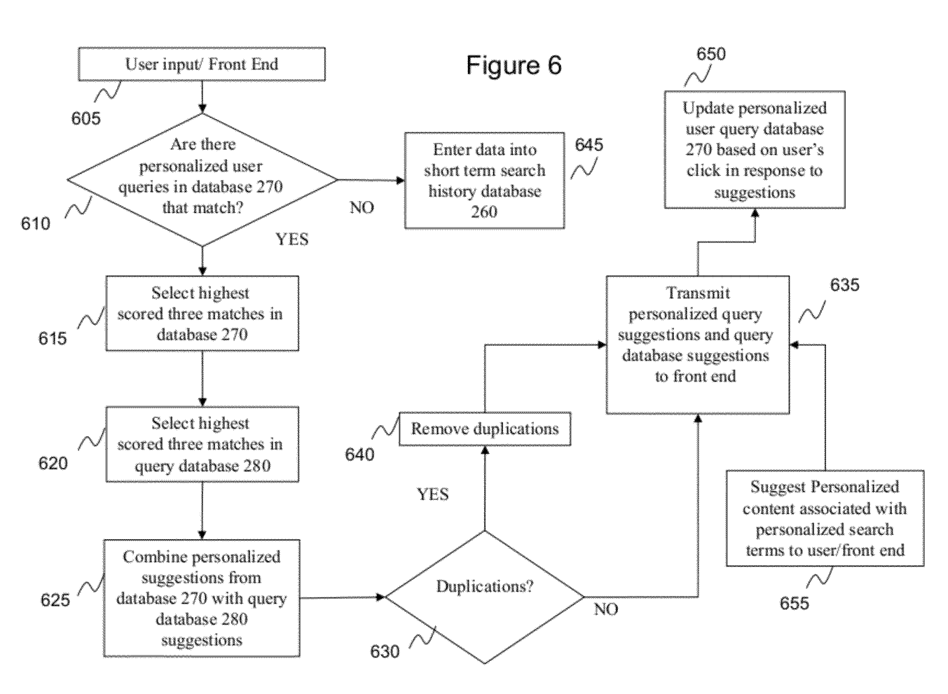

A skipped suggestion is considered any personalized suggestion that is presented before or above the actual clicked suggestion. FIG. 7 depicts an example of a user entering a query into a search engine for Fandango. Assuming the user has the following queries stored in their personalized user database 270: “facebook”, “free online games”, “facebook login”, “fantasy football” and “fandango”, FIG. 7(a) depicts what the user may see when they begin to enter the query by typing the letter “f” in search box 700. The user is presented with two personalized suggestions, “Facebook” and “Free on line games” in personalized search window 710. Neither of these results are what the user is looking for, so the user continues typing “Fa” as seen in FIG. 7(b). “Free on line games” is replaced by “Facebook login”, in personalized search window 710, but the user keeps typing. In FIG. 7(c) the user continues to type in search box 700 “Fan” and is presented with personalized query suggestions “Fantasy football” and “Fandango” in personalized search window 710. The user then clicks on Fandango. This information is utilized to update the personalized database. With respect to the example depicted in FIG. 7, the “Fandango” query entry will be updated by updating timestamp 507, incrementing K_Value 512 and Nclick 514, and re-computing score 522. Correspondingly, all the personalized entries presented before “Fandango”, i.e., “facebook, free online games, facebook login and fantasy football” are all considered skipped entries and their respective entries in personalized database 270 are updated as well. For the skipped entries, NSkip 516 is incremented by 1 and score 522 is recalculated using the new NSkip 516 value

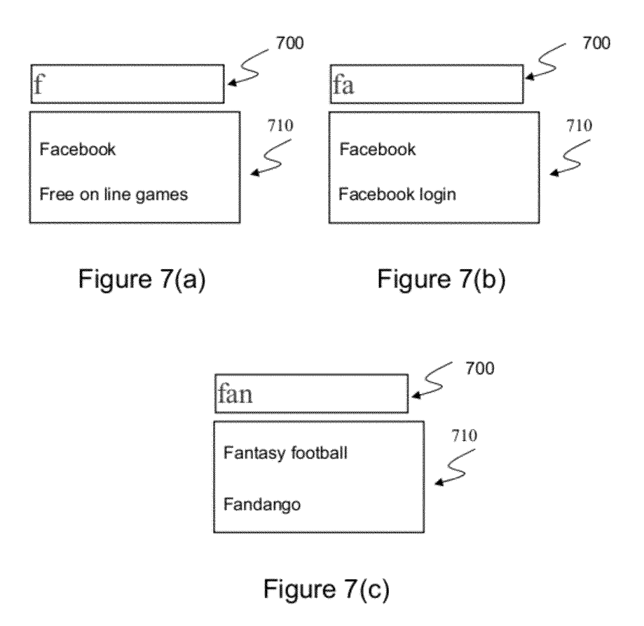

FIG. 8 represents the detection stage in an embodiment for detecting or mining a user's personalized queries from the user's short term or short term search history database 260 and the user's long term query history from user long term database 250. This information is utilized to populate and update a user's personalized user database 270. The embodiment disclosed in FIG. 8, is used to populate the personalized user database 270. It consists of two algorithms running in parallel, although other system architectures, such as periodic mining from the long term database or not utilizing a short term search history database, are possible. As noted, in one embodiment, the user's real time queries are logged in short term search history database 260 for near real time processing. These entries are sent on a periodic schedule, usually daily to the user long term database 250, where trend data and a more complete analysis can be performed, although other shorter or longer periods may be suitable as well. While the data contained in the user long term database 250 it typically more accurate of a user's bookmark behaviors, it requires data collected over an extended period of time. Accordingly, in an embodiment, the detection stage utilizes both the short term search history database 260 data and the user long term database 250 data to populate the personalized user database 270.

The detection stage may be run on a single processor or may be distributed across a network or across several processors. Similarly, short term search history database 260 and user long term database 250 may be housed in a single location or may be distributed across several locations or networks. As depicted in FIG. 8, a user enters a query at step 800 via the front end usually through a search engine. In step 810 the query is written into short term search history database 260 and feeds the Exact Query Click/Exact Query Click-Exclude (EQC/EQC-E) algorithm at step 820. The output of EQC/EQC-E algorithm is used to populate or update, as the case may be personalized user database 270 at step 830. Similarly, the data once written into User Long Term (ULT) database 250 is used in step 840 to feed the Non-Exact Query Single Identical Click (NEQSIC) algorithm at step 850. In turn, the output of the NEQSIC algorithm populates and updates the values of personalized user database 270 at step 830. Once an entry has been written into personalized user database 270, it may be combined with suggestions from query database 280 before being presented to a user at step 880.

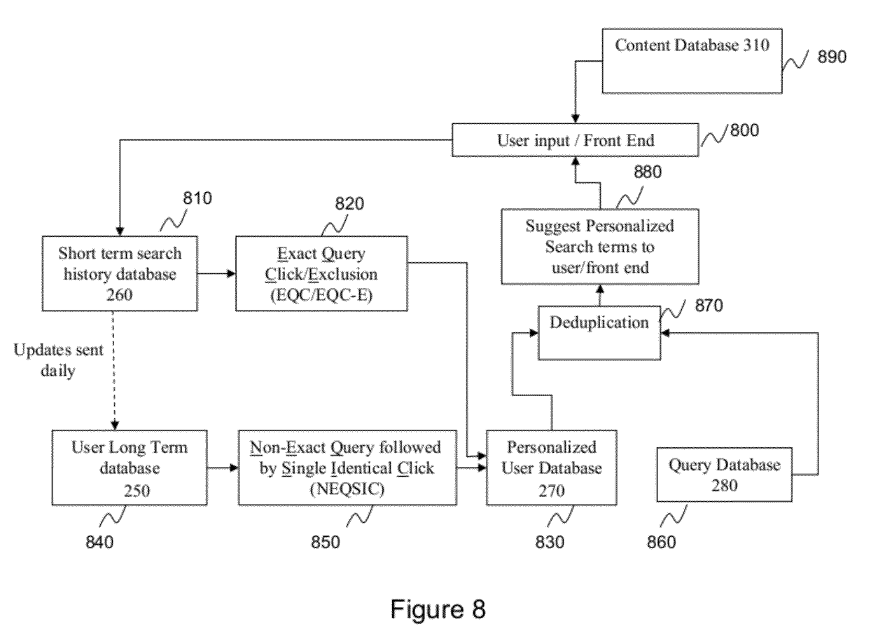

FIG. 9 depicts the EQC algorithm in an embodiment. At step 900, user 210 enters a query at the front end. At step 905, the front end monitors the user's interactions to determine if the query entered at step 900 is followed by a click on a suggested URL. At step 910, it is determined if the exact query followed by the identical URL click is in the short term search history database 260. If it is already in the database, the timestamp is updated and the K_Value is incremented at step 920. If it is not already in short term search history database 260, then at step 915, an entry is created in short term search history database 260. The new entry would include query 502, timestamp 506, URL 508, K_Value 512=1, NClick 514=0, NSkip 516=0 and score 522. At step 925 the K_Value is analyzed to determine if it exceeds a preset threshold value. If it does exceed the threshold value the system waits for the next query entry. Initially, NClick 514, and NSkip 516 are set to 0, timestamp 506 represents the time it was written into database 270 and flag 510 would be set to represent it was written utilizing the EQC method. In one embodiment, a threshold value of 2 for K_Value 512 was used, although higher values could be used. If and when the query has been entered a number of times, such that K_Value 512 is greater than the preset threshold, the entry will be moved to the personalized user database 270 at step 930. If an entry for the query already exists in database 270, then its entries are updated at step 940. If the entry does not exist in personalized user database 270 then a new entry is created at step 940. The entry in one embodiment is in accordance with the data structure depicted in FIG. 5.

In this manner, a query that is repeated on a short term basis, such as one that is repeated during the same session may be moved quickly into the personalized user database 270 without the data having to travel to the user long term database 250 first. To ensure that user's short term search history database 260 does not come over burdened with entries that a user 210 queries several times and then abandons, the EQC method is also employed to exclude entries from the personalized user database 270.

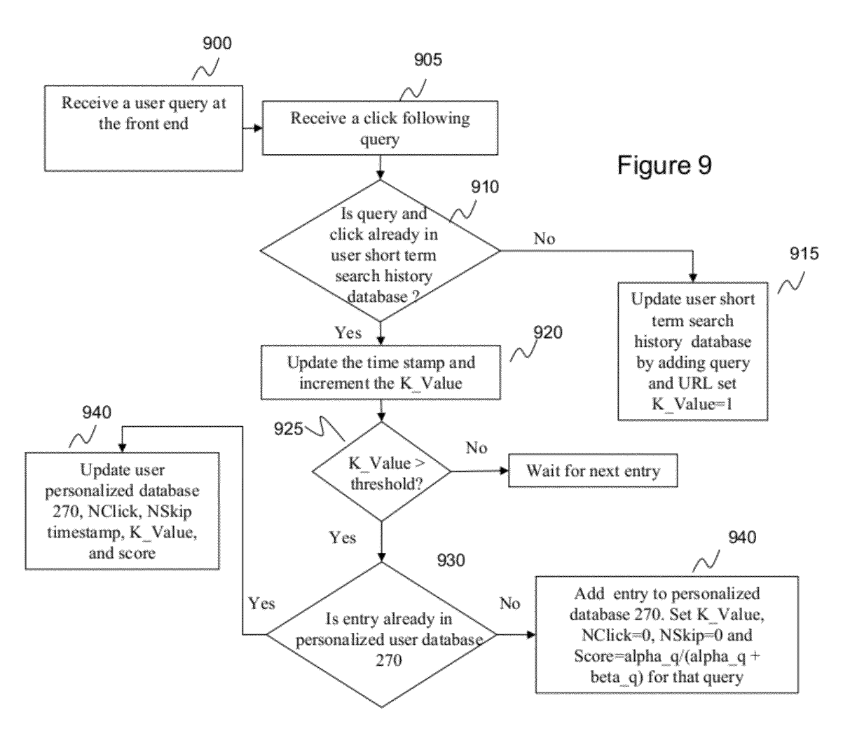

FIG. 10 depicts the EQC-E feature of an embodiment. Steps 900-940 proceed as in the EQC described with respect to FIG. 9. Once it is determined that the query is to be written into the user personalized database 270, step 1010 checks the time stamp 506 value for the query in personalized search database 270 to determine when the last time the user entered such a query or the last time the suggestion for the query was ever clicked. At step 1020, flag 510 is checked to determine if the entry was written to the database by the EQC method or the NEQSIC method. If it was written by the NEQSIC method indicating the user's long term interest in the query, it's information in the personalized database 270 is updated. If it was written by the EQC method, the current timestamp is compared to the existing timestamp at step 1030 to determine the amount of time since the query was last issued or clicked. If the timestamp 506 exceeds a threshold period, then it is removed from the personalized database 270 because the user has not shown enough recent interest in the query to warrant it remaining in the personalized database 270. If the period does not exceed the threshold, then the entry for the query in personalized database 270 is updated. In an embodiment a 24 hour threshold was used, although any other longer or shorter period could be utilized. Although the EQC method can perform almost in real time, the queries detected by the EQC method are not likely to be useful in the long term. Accordingly, if a personalized query suggestion that gets excluded from the personalized database 270 by the EQC-E method deserves to be in there, i.e. it is important to the user, it will get back through the user long term database 250 or NEQSIC processing.

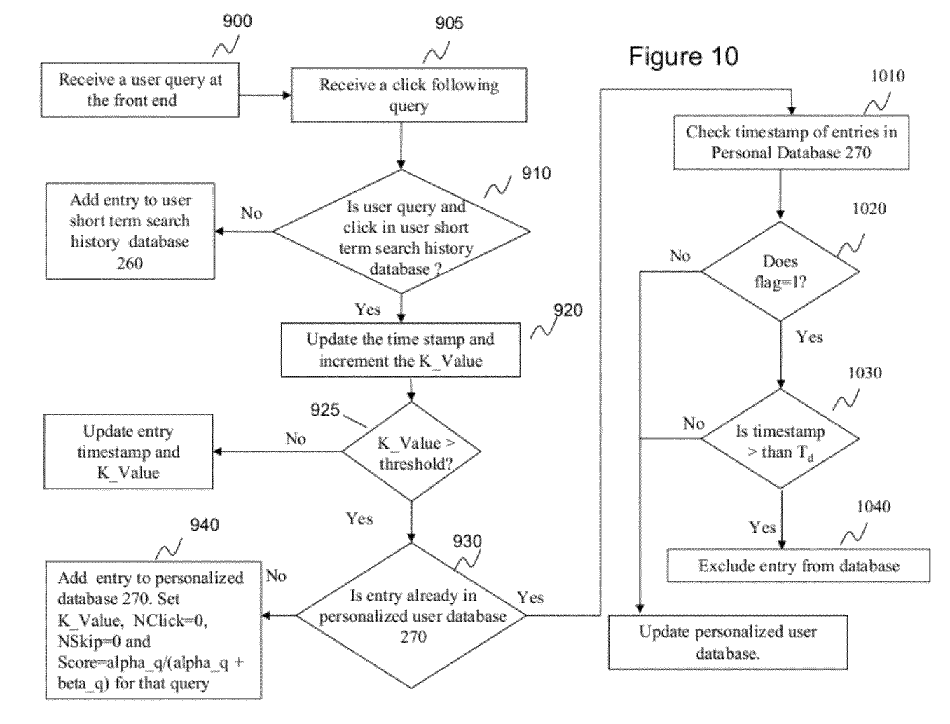

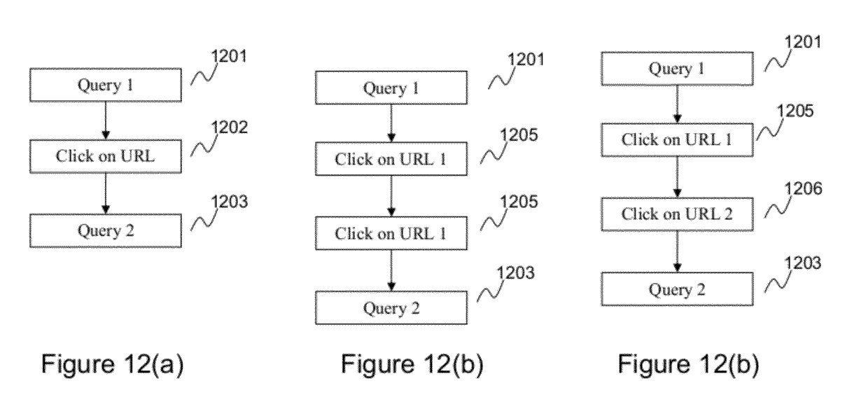

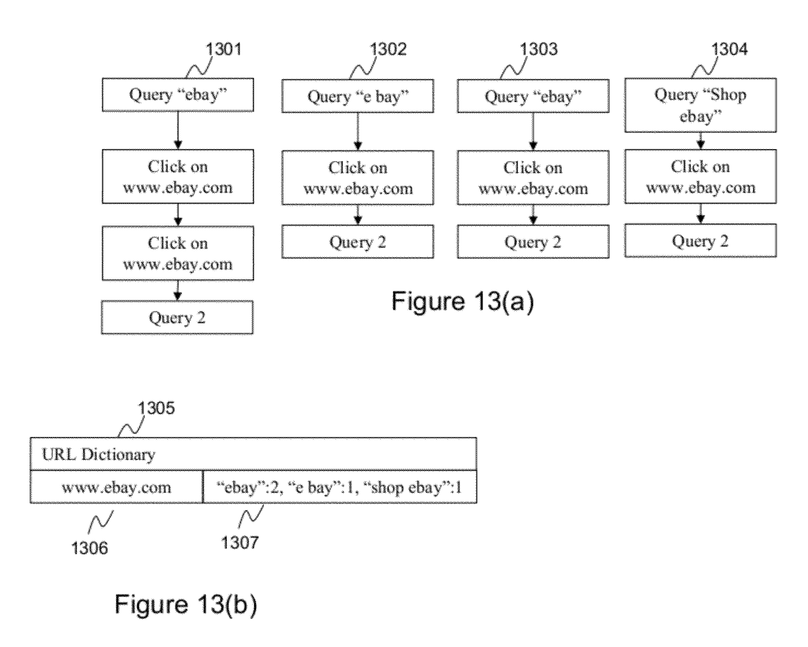

FIG. 11 depicts the Non-Exact Query Single Identical Click (NEQSIC) method used in an embodiment to extract personalized user query suggestions from the user long term database 250. As the data in the user long term database 250 is not written into the database in real time, the analysis step 1105, of user long term database 250 does not take place in near real time, but may be scheduled at off peak hours or when best suited to take advantage of available system resources. At step 1110 the data is analyzed to determine if the query was followed by a single click on an identical URL. In an embodiment, a single click is defined as a click on only one identical URL between two subsequent queries. For each user 210, NEQSIC builds a dictionary of each single click URL where the keys are the queries that lead to the single click URLs and the values of the counts of each occurrence. As depicted in FIG. 13(b) a dictionary may include multiple queries that all lead to the same URL after a single WEB click.

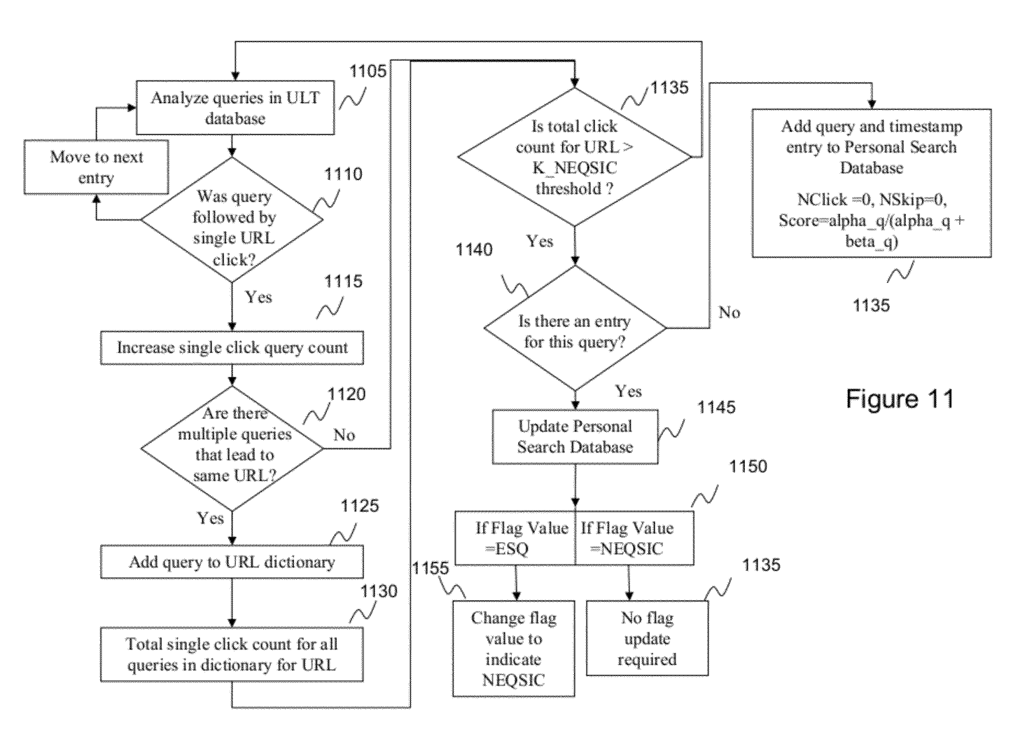

Examples of single web clicks are depicted in FIG. 12(a)-(c). In FIG. 12(a) a user enters query1 1201 and clicks in URL 1202 and then enters query2 1203. This is a single web click because the click on URL 1202 was the only action that occurred between the two queries 1201 and 1203. In FIG. 12(b) the user enters query1 1201 and clicks on URL1 1205 and again on URL1 1205 and then enters query2 1203. This too is considered a single web click because the user clicked on the same URL1 twice between queries, presumably because the URL1 did not load fast enough. The user did not click on a second URL between the queries. In FIG. 12(c) the user enters query1 1201 clicks on URL1 1205 and then on URL2 1206 before entering query2 1203. This is not a single web click because the user clicked on two different URLs between queries.

Returning to FIG. 11 if at step 1110 a single URL click is detected, the entry for the query is incremented at step 1115. If a single web click is not detected, the system moves to the next entry and returns to step 1105.

Step 1120 determines if there are multiple queries that lead to identical single web clicks on the same URL. FIG. 13 depicts various examples in an embodiment of single clicks utilizing different queries that all lead to the same URL. Single clicks 1301-1304 are all single web clicks that result in the user clicking on the URL for www.ebay.com. The user's “dictionary” 1305 for the URL www.ebay.com is depicted in FIG. 13(b). Entry 1306 represents the URL and 1307 lists the various queries and the respective counts for each query.

Returning to FIG. 11, if multiple queries leading to the same URL are detected at step 1120, the query is added to the user's dictionary 1305 and the query count is incremented. If at step 1120 there are not multiple queries that lead to the same URL, but merely single identical clicks from the same query, the user dictionary 1305 is updated and query count 1307 is incremented. At step 1130, the queries 1307 in the user's dictionary 1305 for a particular URL 1306 are totaled. If the total count for the URL entry in user dictionary 1305 exceeds a threshold K_NEQSIC at step 1335, then the URL and the query are moved to personalized user database 270. In an embodiment, a K_NEQSIC threshold value of 5 was found to be sufficient, however any threshold could be utilized. It should be noted, that in an embodiment, the query with the highest number count is listed as the suggested query and not every variation of the query that led to the identical URL. Step 1140 checks personalized user database 270 to determine if an entry for the URL exists. If it does, then at step 1145, the entry in personalized user database 270 is simply updated rather then created. If at step 1150, flag 510 for the URL is set to indicate that it was originally written using the EQC method, flag 510 is updated at step 1155 to indicate it has now been written to personalized user database 270 via the NEQSIC method. If at 1150 it is determined that flag 510 was written as a result of the NEQSIC method then no update to flag 510 is required. If at step 1140, it is determined that no entry exist in personalized user database 270, an entry is created. Setting NClick 514 to 0, NSkip 516 to 0, K_Value 512 to 0 and score 522 to (alpha_q/(alpha_q+beta_q)).

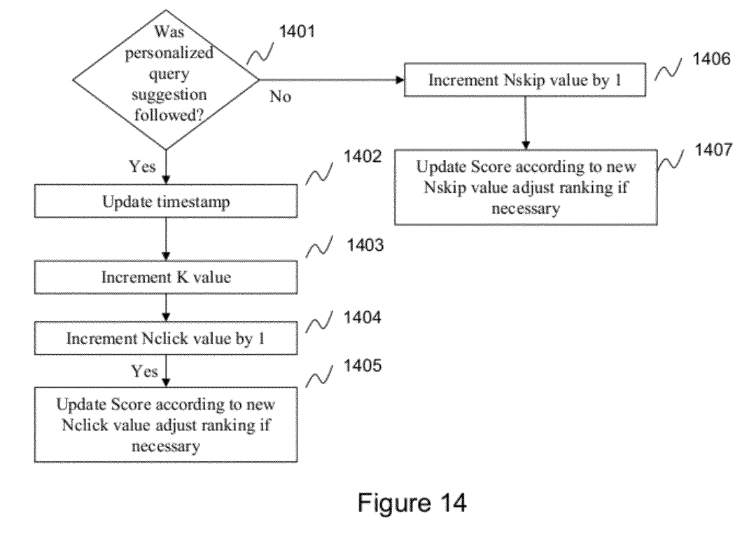

FIG. 14 depicts the personalized user database values that are updated when a personalized suggestion is followed or skipped in an embodiment. At step 1401 it is determined whether the suggested query was followed or skipped. If followed, the timestamp 506 is updated at step 1402, the K_value 512 is incremented and the NClick value 514 is incremented by 1. At step 1405, score 522 is recalculated and the ranking is adjusted if necessary. If the suggested query is skipped at 1401, the NSkip value 516 is incremented at step 1406 and the score 522 is updated and the ranking adjusted as necessary at step 1407.

Once an entry is written into personalized user database 270 it must be ranked so as to determine its placement among the suggested queries. Since score 522 is updated after each interaction with the personalized suggestion, based on NSkip 516 or NClick 514 values, the ranking is simple. At any given time the rows of personalized user database 270 that match the query that the user is entering at the front end are ranked by score as long as all the NClick and NSkip information is available. If however, some of the features such as NClick or NSkip values are unavailable, other scoring or ranking functions may be used.

TABLE 1

| Scenario | Scoring Function |
|---|---|
| All features are available for all | (NClick + alpha_q/NClick + NSkip + |
| queries (both the EQC and | alpha_q + beta_q) |
| NEQSIC queries) | |
| All features are available for | (NClick + alpha_q/NClick + NSkip + |
| NEQSIC queries, but only last | alpha_q + beta_q) for NEQSIC |
| click timestamp is available | queries, then backfill from EQC |
| for ESC queries | sorting by the last click timestamp |
| | (more recently clicked ranks higher) |
| All features except NSkip are | Use exponential smoothing formula |
| available for all queries | |
| All features except NSkip are | Use exponential smoothing formula for |
| available for NEQSIC queries, | NEQSIC, then backfill from EQC |
| only the last click timestamp | sorting by the last click timestamp |
| available for EQC queries. | (more recently clicked ranks higher) |

In an embodiment, if NSkip is not available for scoring, an exponential smoothing formula may be used to aid with scoring. In an embodiment, x_q(t) is a query-level discrete time signal indicating whether there is a click on a query suggestion (x_q(t)=1) or not (x_q(t)=0) for the given time interval. From the click times (which are in the continuous scale), one should do a binning with a time window of approximately every 10 minutes to obtain x_q(t). The score can be obtained using an exponentially smoothed version of x_t as s_q(t)=a*x_q(t−1)+(1−a)*s(t−1); if x_q(t−1)=0, a=some constant; if x_q(t−1)=1, a=(1+s(t−1))/2. This can be rewritten as a function of the current time, last click time, and score as the last click time. If obtaining the score at the last click time may cause a problem, this can be approximated by counting NClick for a few different time windows. For example, NClick_total, NClick_in_last_day, NClick_in_last_week, etc.

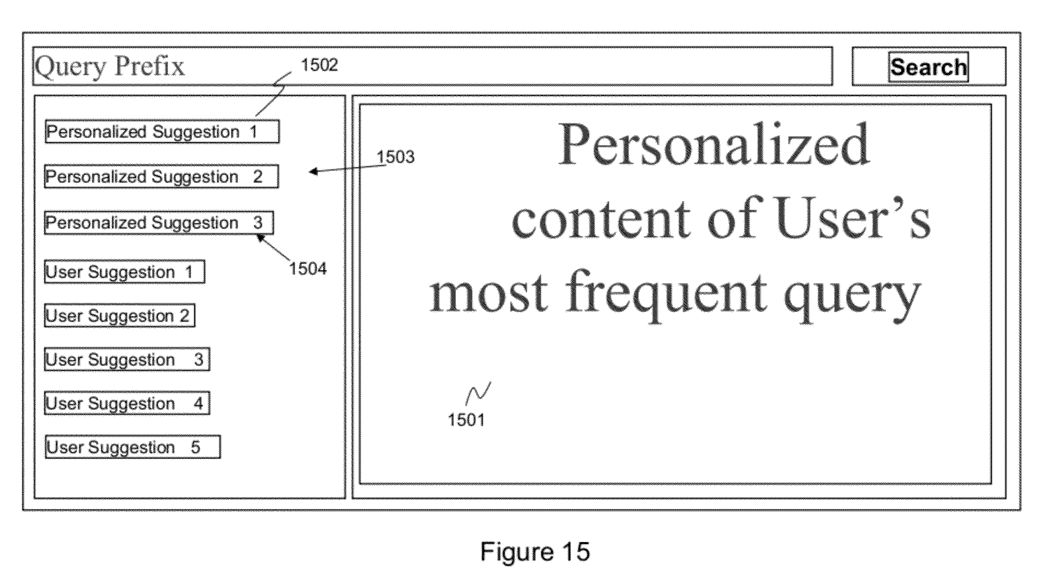

In another embodiment of the invention, in addition to presenting the user 210 with personalized query suggestions, the user 210 is presented with content from content system 310 related to the personalized query suggestion as well. For example, FIG. 15 depicts an embodiment where in addition to personalized query suggestions 1502-1504, the user is presented with personalized content in area 1501 related to the personalized suggestion 1502. Such additional personalized content may be associated with the URL associated with each suggestion, or may be advertisement associated with the URL or information related to the URL. It may be an advertisement for a competing product or related product. For example, a user whose personalized query suggestions include Lake Tahoe Ski Reports may receive advertisements directed to Lake Tahoe Condominium rentals or ski equipment from content system 310. In an embodiment, providers present personalized content which may be housed on or retrieved by content system 310 tied to personalized queries based on placement of content in relation to the personalized search queries 1502-1504. In an embodiment, the user 210's interactions with the personalized content presented in area 1501 is monitored and tracked. In another embodiment, the placement of personalized content in area 1501 is tied to the ranking of the personalized search query.

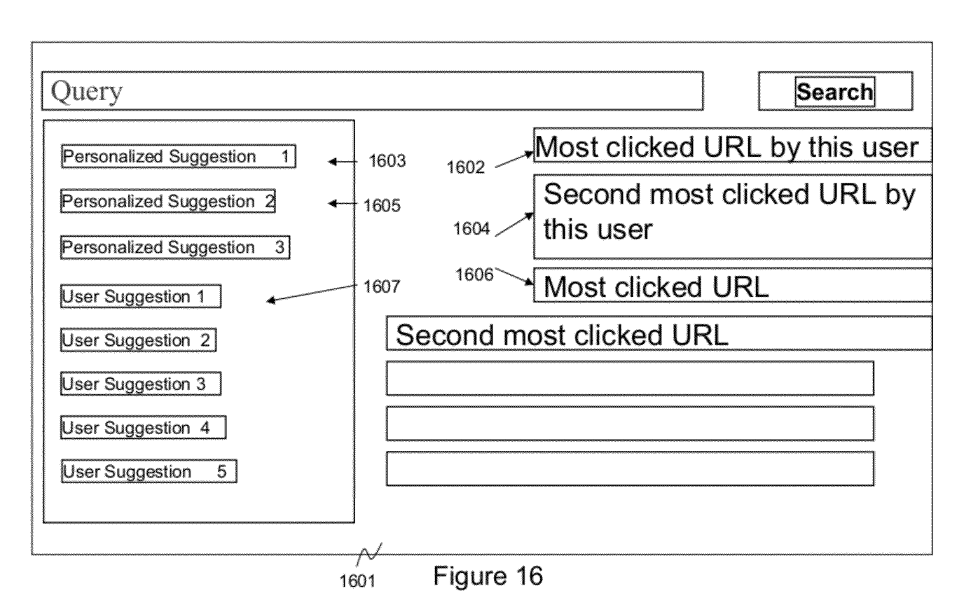

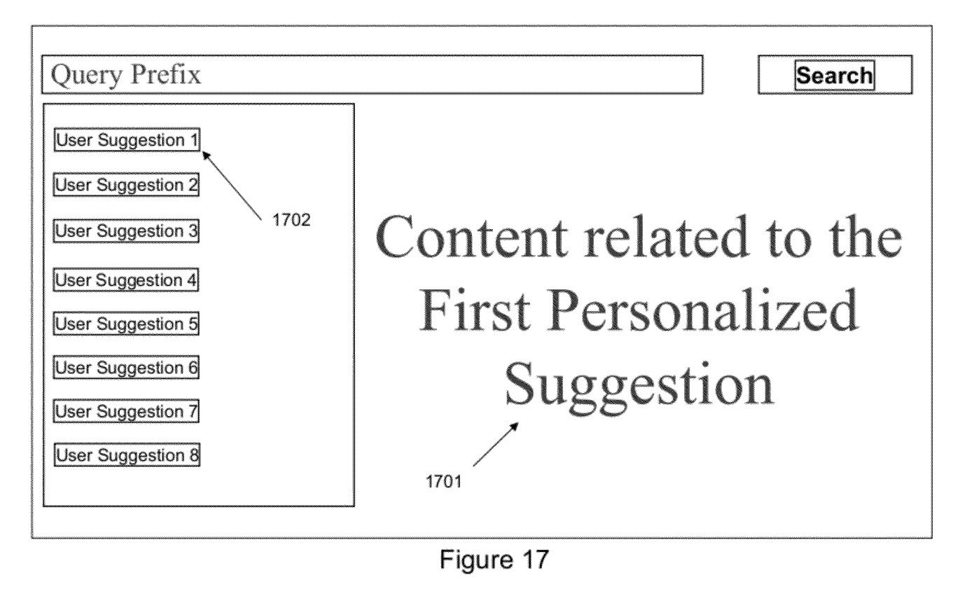

Similarly, FIG. 16 depicts an alternative embodiment, where personalized content 1601 is displayed for multiple URLs based on the scoring of each URL associated with the user's query. For example, content 1602 corresponds to the URL associated with the first personalized suggestion 1603 and content 1604 corresponds to the URL associated with the second personalized suggestion 1605. Similarly, content 1606 may correspond to the first user suggestion 1607 obtained from query database 280. Where no personalized suggestions are available from the personalized user database 270 for the specific user query, FIG. 17 depicts an embodiment where content 1701 may be associated with the first user suggestion 1702 obtained from query database 280.

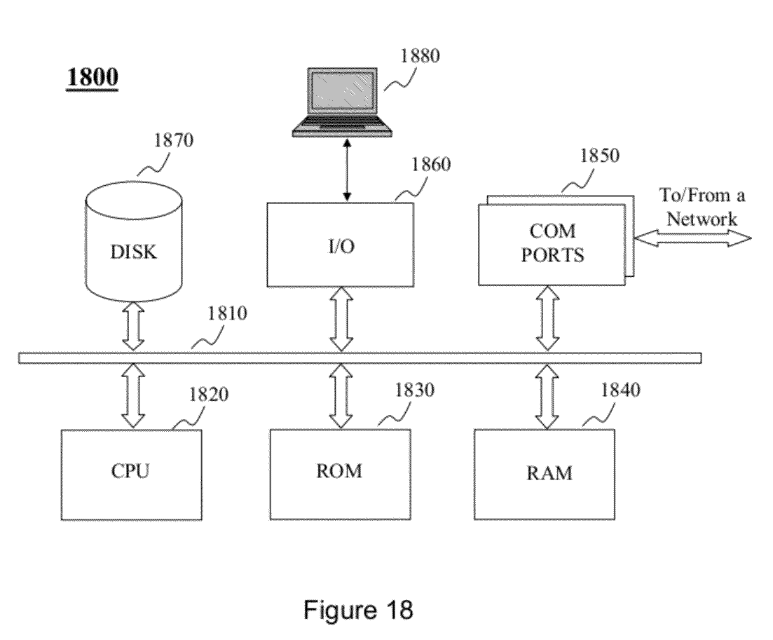

FIG. 18 depicts a general computer architecture on which the present teaching can be implemented and has a functional block diagram illustration of a computer hardware platform which includes user interface elements. The computer may be a general purpose computer or a special purpose computer. This computer 1800 can be used to implement any components of the personalized suggest-as-you-type generation architecture as described herein. For example, the personalized query engine 240 that analyzes personal search queries, the search engine 230, the short term search history database 260 that houses the user's near real time queries, the user long term database 250 that tracks a user's long term queries, personalized database 270 that contains the user's personalized suggestions, query database 280 that contains the overall populations query suggestions and content system 310 can all be implemented on a computer such as computer 1800, via its hardware, software program, firmware, or a combination thereof. Although only one such computer is shown, for convenience, the computer functions relating to personalized search query may be implemented in a distributed fashion on a number of similar platforms, to distribute the processing load.

The computer 1800, for example, includes COM ports 1850 connected to and from a network connected thereto to facilitate data communications. The computer 1800 also includes a central processing unit (CPU) 1820, in the form of one or more processors, for executing program instructions. The exemplary computer platform includes an internal communication bus 1810, program storage and data storage of different forms, e.g., disk 1870, read only memory (ROM) 1830, or random access memory (RAM) 1840, for various data files to be processed and/or communicated by the computer, as well as possibly program instructions to be executed by the CPU. The computer 1800 also includes an I/O component 1860, supporting input/output flows between the computer and other components therein such as user interface elements 1880. The computer 1800 may also receive programming and data via network communications.

Hence, aspects of the methods of receiving user queries and returning a response, e.g., a URL associated with dynamically generated web pages or the content contained in the dynamically generated web pages, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the search engine operator or other explanation generation service provider into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, at least one storage device, and a communication platform connected to a network for providing personalized search query suggestions to a user as the user enters a search query, comprising the steps of:
receiving, via the communication platform, a portion of a query originated from the user,
comparing the received portion of the query to data stored in a first database and a second database;
generating a first set of query suggestions based on the comparing;
generating a second set of query suggestions based on the comparing;
combining the first set of query suggestions and the second set of query suggestions,
and
transmitting, via the communications platform, the combined set of query suggestions before the user completes the query,
wherein the first set of query suggestions is based on information stored in the first database and the second set of query suggestions is based on information stored in the second database.

2. The method of claim 1 further comprising the following:
associating at least one personalized content to the corresponding at least one set of combined query suggestion, and
transmitting, via the communications platform, the at least one personalized content.

3. A method, implemented on a machine having at least one processor, storage, and a communication platform connected to a network for generating a personalized query suggestion to a user as the user enters a query, comprising the steps of:
receiving a first search query originated from a user;
monitoring the user's response to the search query;
comparing the user's response and the search query to data in a personalized database associated with the user;
updating the personalized database based on the results of the comparing;
storing the first search query and the response in the personalized database; and
outputting a personalized query suggestion to a future query, before the user completes the query, that is related to the first query based on the response stored in the personalized database.

4. The method of claim wherein the storing occurs in response to the updating exceeding a threshold.

5. The method of claim 3 wherein the storing includes storing a plurality of different queries associated with a single universal resource locator.

6. The method of claim 3 further comprising contemporaneously outputting personalized content related to the personalized suggestion.

7. The method of claim 3 wherein the personalized suggestions are ranked based on the user's interactions with past suggestions.

8. The method of claim 3 further comprising the steps of:
removing the query and the corresponding response from the personalized database when the query and the response exceed a temporal threshold.

9. A machine readable non-transitory and tangible medium having information recorded thereon for suggesting personalized queries to a user as the user enters a query, wherein the information, when read by the machine, causes the machine to perform the following:
receiving a first search query originated from a user;
monitoring the user's response to the search query;
comparing the user's response and the search query to data in a personalized database associated with the user;
updating the personalized database based on the results of the comparing;
storing the first search query and the response in the personalized database; and
outputting a personalized query suggestion to a future query, before the user completes the query, that is related to the first query based on the response stored in the personalized database.

10. The medium of claim 9 further comprising contemporaneously outputting personalized content related to the personalized suggestion.

11. A method for presenting personalized content, comprising:
tracking, via a machine having at least one processor, at least one storage device, and a communication platform connected to a network, personalized search queries associated with a user;
receiving, via the communication platform connected to the network, information related to a plurality of personalized content from a content provider based on the personalized search queries associated with the user;
associating, via the at least one processor, one or more personalized content with respect to the one or more personalized search queries; and
presenting, via the machine, contemporaneously with the personalized search queries, the one or more personalized content when the one or more personalized search queries are displayed.

12. The method of claim 11, further comprising:
obtaining, via the machine, information related to presentation of the one or more personalized content in connection with the one or more personalized search queries; and
determining, via the at least one processor, statistics associate with the presentation of the one or more personalized content;
updating a storage record associated with the content provider in connection with the one or more personalized content based on the statistics; and
receiving a payment made in association with the one or more personalized content and computed based on the record.

13. The method of claim 11 where the personalized content is n advertisement and the content provider is an advertiser.

14. The method of claim 12 where the personalized content is an advertisement and the content provider is an advertiser.

15. A system, comprising a machine having at least one processor, one storage, and a communication platform connected to a network, for providing personalized query suggestions to a user as the user enters a search query, comprising:
a personalized query engine configured for receiving, processing, and generating personalized search queries based on a search query prefix entered by a user, and
a search engine configured for receiving the search query prefix from a user;
wherein upon receiving a search query prefix from the user, the personalized query engine:
retrieves information from a knowledge storage associated with the user,
generates one or more one or more personalized search queries, and
transmits the one or more personalized search queries in response to the search query prefix.

16. The method of claim 1 wherein the first database is specific to the user and the second database is common to all users.

17. The method of claim 1 further comprising presenting, to the user via a drop down menu, the combined set of query suggestions.
